(19) United States
(12) Patent Application Publication
(10) Pub. No.: US 2026/0126027 A1
(43) Pub. Date: May 7, 2026

(54) INFRASTRUCTURE FOR RENEWABLE ENERGY POWER GENERATION INCLUDING INFRASTRUCTURE FOR THERMAL CYCLE BASED AT LEAST IN PART ON GRAVITATION FORCE

(71) Applicant: ENERGY CARNOT INNOVATORS CORPORATION, Squamish (CA)

(72) Inventors: Ovidiu Marin, Chapel Hill, NC (US); Calvin Winter, Squamish BC (CA)

(21) Appl. No.: 19/258,819

(22) Filed: Jul. 2, 2025

Related U.S. Application Data
(60) Provisional application No. 63/833,217, filed on Nov. 7, 2024.

(51) Int. Cl. F03B 17/00

(52) U.S. Cl. CPC F03B 17/005

(57) ABSTRACT

The present disclosure relates generally to infrastructure for renewable energy power generation, and is directed more particularly to infrastructures for thermal cycles for continuous and/or modulated power generation based, in whole or in part, on gravitational force, including infrastructures for lower grade heat recovery.

This patent application claims the benefit of and priority to U.S. Provisional Patent Application No. 63/833,217, filed Nov. 7, 2024, which is incorporated herein by reference in its entirety.

### BACKGROUND

### 1. Field

The present disclosure relates generally to infrastructure for renewable energy power generation, and is directed more particularly to infrastructures for thermal cycles for continuous and/or modulated power generation based, in whole or in part, on gravitational force, including infrastructures for lower grade heat recovery.

### 2. Information

At present time, the world's demand for electrical power is increasing, and is predicted to continue to increase substantially in the coming years. For example, emerging technologies, such as Artificial Intelligence-type technologies, block-chain and/or other cryptographic-type technologies, electric vehicles, etc., may place greater electrical power demands on communities and nations around the world. Developing nations will also consume greater amounts of electrical power in the future. At the same time, efforts to reduce emissions and/or other waste products related to electrical power generation may continue to grow in importance. For these reasons, and others, development of scalable and reliable technologies for electrical power generation via clean, renewable energy sources continues to be an active area of investigation.

### DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is an illustration depicting a simplified view of a renewable power generation system comprising a first column containing a gas and a second column containing a liquid, and further comprising one or more objects cycling through both columns, according to an embodiment.

FIG. 2 is an illustration depicting an example renewable power generation system comprising a first column containing a gas and a second column containing a liquid, and further comprising one or more objects cycling through both columns, wherein electrical power generation is accomplished, in whole or in part, via the first and second columns, according to an embodiment.

FIG. 3 is an illustration depicting an example mechanism for inserting an object from a bottom portion of a first column containing a gas to a bottom portion of a second column containing a liquid, according to an embodiment.

FIG. 4 is an illustration depicting an example renewable power generation system comprising a column containing a liquid to flow from a top portion of the column to a bottom portion of the column, and further comprising a mechanism to return liquid from the bottom portion of the column to the top portion of the first column, according to an embodiment.

FIG. 5 is an illustration depicting an example renewable power generation system comprising a first column containing a gas and a second column containing a liquid, wherein electrical power generation is accomplished, in whole or in part, via the first column, according to an embodiment.

FIG. 6 is an illustration depicting an example renewable power generation system further comprising one or more heat exchanger units to draw thermal energy from a main liquid of a column into a working fluid, according to an embodiment.

FIG. 7 is a flow diagram illustrating an example process for generating power at least in part via a liquid flow, according to an embodiment;

FIG. 8 is a flow diagram illustrating an example process for generating power at least in part via descent of one or more objects due at least in part to a gravitational force, according to an embodiment;

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others, one or more aspects, properties, etc. may be omitted, such as for ease of discussion, or the like. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, or the like described are capable of being combined in various ways in one or more implementations and/or embodiments and, therefore, are within intended claim scope. In general, of course, for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers at least to the context of the present patent application.

As alluded to previously, at present time, the world's demand for electrical power is increasing, and is predicted to continue to increase substantially in the coming years. For example, emerging technologies, such as Artificial Intelligence-type technologies, block-chain and/or other cryptographic-type technologies, electric vehicles, etc., may place greater electrical power demands on communities and nations around the world. Developing nations will also consume greater amounts of electrical power in the future. At the same time, efforts to reduce emissions and/or other waste products related to electrical power generation may continue to grow in importance. For these reasons, and others, development of scalable and reliable technologies for electrical power generation via clean, renewable energy sources continues to be an active area of investigation.

It may be notable that power generation may produce approximately one-third of emissions contributing to climate change, it has been estimated. Emission-free, or “green,” power generation is often limited to particular geographies, such as where there may exist advantageous sun and/or wind-based energy conditions and/or advantageous water conditions for hydro-electric power generation, for example. Renewable energy-based power generation may, in many circumstances, be based, in whole or in part, on solar, wind, and/or wave energy which may be, at least at times, unpredictable and/or which may vary over time. Geothermal-based approaches may provide more predictable and/or constant power generation, but such approaches may be generally restricted to particular geographic locations and/or to particular conditions, for example. It may be notable that many power generation approaches may rely, in whole or in part, on thermal processes, such as, for example, Rankine and/or Brayton cycles which may exhibit relatively lower efficiencies, such as compared with a theoretical maximum Carnot cycle efficiency, for example.

Embodiments described herein may address, in whole or in part, issues discussed above using approaches based, in whole or in part, on natural energy that may be relatively non-polluting and/or that may find advantageous application in a wide range of geographic locations and/or environmental conditions. Embodiments may be based, in whole or in part, on gravitational energy and/or lower-grade thermal energy, such as may be found in nature, for example. Embodiments may include infrastructure to harness gravity force, Archimedes law, heat transfer, and/or fluids, for example, to generate relatively efficient, inexpensive, “free,” and/or relatively limitless electrical power, for example. In embodiments, a power generation cycle may produce relatively continuous electrical power, in a flexible manner, that may be relatively easy to modulate in accordance with power needs, for example, and that may be advantageously applied anywhere in the world.

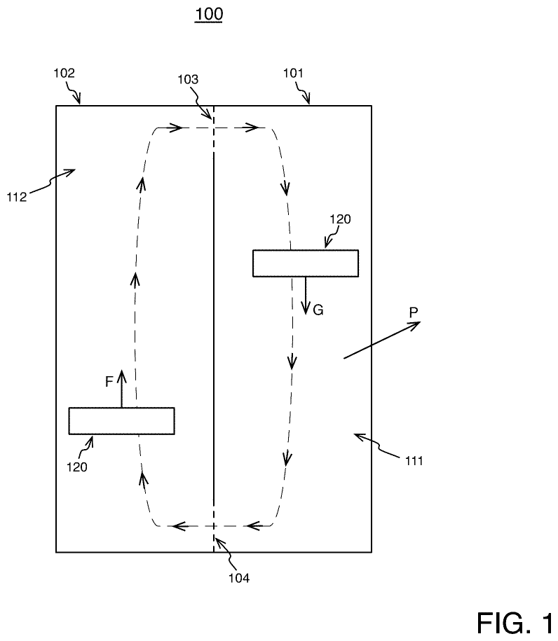

FIG. 1 is an illustration depicting a simplified view (e.g., for ease of initial explanation) of an embodiment 100 of an example renewable energy power generation system. In one or more embodiments, one or more objects 120 (e.g., masses comprising any of a wide range of materials, configurations, techniques of manufacture, etc.) of weight “W” and density “D_{W}” may circulate between two media, for example, as depicted in FIG. 1. In one or more embodiments, a first column 101 may be filled, at least in part, with a gas 111 of density D₁, and a second column 102 may be filled, at least in part, with a liquid 112 of density D₂. In one or more embodiments, density D_{W} of object 120 may be lower (e.g., relatively slightly lower) than density D₂. For example, density D_{W} of object 120 may be 5% to 20% lower than density D₂, although subject matter is not limited in scope in these respects. In one or more embodiments, this may create a vertical force “F” on object 120, wherein F=(D₁−D_{W})*g*V, wherein “V” represents a volume of object 120 and wherein “g” represents acceleration of gravity (e.g., 9.82 m/s² on Earth). In one or more embodiments, vertical force F may lift object 120 towards an upper portion of liquid-filled column 102, as depicted in FIG. 1.

“Column” and/or the like in this context refers to a vessel, enclosure, container, reservoir, conduit, pipe, etc. capable of retaining, maintaining, and/or directing a liquid or a gas, or a combination thereof. In one or more embodiments, a column may be capable of retaining, maintaining, and/or directing a liquid or a gas, or a combination thereof, at a suitable range of pressures within suitable bounds (e.g., within a suitable threshold for leakage). In one or more embodiments, columns may be implemented with a wide range of heights, radii, materials, manner of construction or manufacture, etc., and/or may be implemented to accommodate a wide range of suitable liquids and/or gasses, as discussed more fully below. It may be noted that subject matter is not limited in scope to the specific examples provided herein.

In one or more embodiments, once object 120 has reached an upper portion of column 102, object 120 may be moved, such as in a horizontal fashion, into an upper portion of gas-filled column 101. In one or more embodiments, an opening 103 and/or a door and/or the like may allow for horizontal movement of object 120. In one or more embodiments, there may be relatively little friction involved in such horizontal movement of object 120, and/or relatively little energy may be consumed in moving object 120 in this manner.

In one or more embodiments, density D₁ of a gas contained in column 101 may be lower than density D_{W} of object 120. A gravitational force “G” may cause object 120 to travel from an upper portion of column 101 to a lower portion of column 101, as depicted in FIG. 1. In one or more embodiments, power generated, in whole or in part, via descent of object 120 through column 101 as a result of force G may be extracted, in whole or in part, by mechanical approaches. For example, power “P” may be extracted, in whole or in part, via a power generator unit (not shown) by way of a cable and/or the like that may be pulled (e.g., in concert with a pulley system) by object 120 as it falls, in one or more embodiments. In other embodiments, objects 120 may be placed on supports and/or the like that may be operatively coupled, such as via cables and/or pulleys and/or the like, to a generator to translate, in whole or in part, downward acceleration of objects 120 through column 101 into generated power, for example. Of course, subject matter is not limited in scope in these respects.

Also, in one or more embodiments, as object 120 reaches a lower portion of column 101, object 120 may be reintroduced into column 102 by way of a mechanism 104. As mentioned, embodiment 100 is a simplified example, and exhibits a potential drawback. For example, to reintroduce object 120 into column 102 so that it may be lifted back up through liquid 112 of column 102 so that object 120 may again fall through column 101 and thereby generate additional power, work may be performed against gravity, such as affecting liquid 112, to make room for object 120 within column 102, for example. Embodiments discussed below help address this issue, at least in part. Nevertheless, embodiment 101 depicted in FIG. 1 is helpful in visualizing an example approach, in accordance with one or more embodiments.

Before discussing other embodiments in greater detail, it may be beneficial to note at least some of the potential advantages of embodiments described herein (although, again, subject matter is not limited in scope to the specific examples provided). As may be seen in the discussion above in connection with example system 100 of FIG. 1 and/or in the discussion below in connection with example systems 200, 400, 500, and/or 600, embodiments may include energy generation based, at least in part, on a thermal cycle that is based, at least in part, on gravitational force. This is a significant departure from other approaches that may be based on thermal cycles (e.g., Rankine, Brayton, etc.) that utilize combustion to bring energy into a system, for example, and a number of advantages may be realized.

For example, embodiments may allow for recovery of lower grade heat. As will be seen more clearly in the discussion that follows, approaches described herein may allow for the use of natural and/or residual heat sources, in one or more embodiments. As discussed more fully below, generation of energy and consumption of thermal energy may be independent from each other, in one or more embodiments. This characteristic may allow a system, such as example system 100 (as well as example systems 200, 400, 500, and/or 600, discussed below), to achieve significantly higher efficiencies than other approaches utilizing thermal cycles limited by a maximum Carnot efficiency (1−Tₘᵢₙ/Tₘₐₓ). In one or more embodiments, based at least in part on approaches described herein, for a column, such as column 102, of a theoretical infinite height, efficiency of a cycle may approach 100%. Of course, as previously alluded to, embodiments may implement columns of a wide range of heights, radii, materials, manner of construction or manufacture, etc., and/or may be implemented to accommodate a wide range of suitable liquids and/or gasses.

Also, in one or more embodiments, an ability to recover lower grade heat, for example, may improve efficiencies of a wide range of other approaches to power generation, currently existing, in development, or to be developed in the future. For example, developers, designers, and/or researchers of hydrogen electrolysis systems may be concerned with questions pertaining overall efficiencies and/or amounts of power being lost during hydrogen electrolysis processes. In one or more embodiments, due at least in part to an ability to recover lower grade heat, for example, efficiencies of hydrogen electrolysis systems may be improved. In one or more embodiments, this may be achieved, at least in part, by using heat (e.g., 50° C.) generated as part of a hydrogen electrolysis process to boil-off an appropriate liquid (e.g., to help propel object 120 through the example cycle discussed above in connection with FIG. 1), and thereby recover at least some of the energy consumed by such heat generation. Examples discussing how the boiling-off of appropriate liquids may contribute to energy generation and/or recapture are discussed in more detail below. In one or more embodiments, utilizing such approaches as discussed herein, efficiencies of hydrogen electrolysis systems, by way of non-limiting example, may be improved, thereby leading to greener, more sustainable power generation, for example.

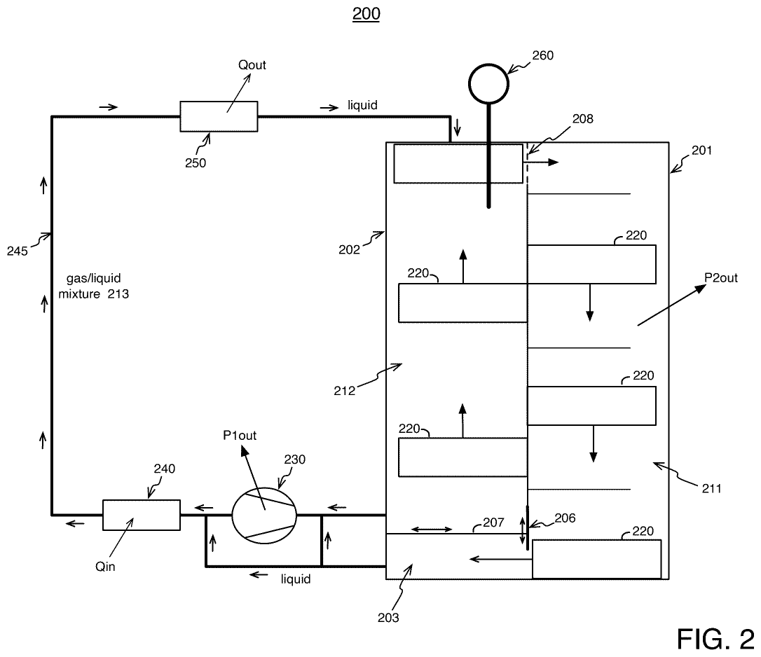

FIG. 2 is an illustration depicting an embodiment 200 of an example renewable power generation system comprising a first column 201 containing a gas 211 and a second column 202 containing a liquid 212. In one or more embodiments, example system 200 may further comprise one or more objects (e.g., masses) 220 cycling through both columns, wherein electrical power generation may be accomplished, in whole or in part, via the first and second columns, according to an embodiment. In the simplified example of FIG. 1, power may be generated via object 120 descending through a gas-filled column. For example system 200 depicted in FIG. 2, power may be generated, in whole or in part, via objects 220 descending through gas-filled column 201 and may also be generated, in whole or in part, by way of gravitational forces acting on liquid 212, in one or more embodiments.

In one or more embodiments, fluid 212, with a given pressure that may be a function of a height of column 202, for example, may be fed via one or more conduits, pipes, and/or other hydraulic coupling mechanisms to a power generator, such as turbine 230. In an aspect, this portion of example system 200 may share some characteristics of a hydro-electric plant, inasmuch as power may be generated, in whole or in part, via a liquid being pushed through a power generation mechanism, for example. As depicted in FIG. 2, power generated at turbine 230 may be labeled P1out, for example. It may be noted that while power may be generated by system 200, in whole or in part, by way of a liquid being pushed through a turbine, for example, example system 200 differs from commonly used hydro-electric-type power plants in that example system 200 provides a mechanism for returning liquid 212 to an upper portion of system 200. By contrast, hydro-electric plants may perform a non-reversible and/or non-continuous process, wherein once water has been consumed, the process ends, for example.

In one or more embodiments, turbine 230 may be similar in at least some respects to types of turbines generally utilized for power generation in connection with any of a range of liquids, such as, for example, water and so forth. In one or more embodiments, a size of turbine 230 may suitable and/or commensurate with a size and/or scale of an installation, for example.

In one or more embodiments, liquid 212, as it exits turbine 230, may be at a relatively higher pressure than liquid 212 at an upper height, such as at an upper portion of column 202, for example. In one or more embodiments, to return liquid 212 from an exit of turbine 230 to an upper portion of column 202, a portion of liquid 212 may be boiled-off (e.g., partially vaporized) as it passes through a heat exchanger 240, for example. In one or more embodiments, an amount of heat Qin may be introduced into liquid 212 via heat exchanger 240 to boil-off at least enough liquid 212 to allow the now two-phase fluid (e.g., gas/liquid mix 213) to travel up from heat exchanger 240 through a return column 245 to an upper height of system 200, for example, and eventually to an upper portion of column 202 to complete a cycle, for example. In one or more embodiments, as liquid 212 is at least partially boiled-off, a density of a resulting gas may increase, and gas and liquid particles may be lifted through return column 245, for example. In one or more embodiments, such an approach may be similar in some respects to a percolator utilized to produce coffee, for example.

In one or more embodiments, as gas/liquid mixture 213 arrives at an upper portion of return column 245, for example, the mixture may be passed through a heat exchanger 250, for example. In one or more embodiments, heat exchanger 250 may remove an amount of heat Qout from gas/liquid mixture 213 to re-liquify liquid 212 at a pressure of that of an upper portion of column 202, for example. In one or more embodiments, re-liquified liquid 212 may be reintroduced to column 202 to complete a cycle and/or to start a new cycle. Of course, liquid 212 may continuously cycle through column 202, turbine 230, heat exchanger 240, column 245, and heat exchanger 250, for example, to generate power P1out, in one or more embodiments.

In one or more embodiments, fluid 212 may comprise any of a wide range of fluids having a boiling temperature and/or pressure within convenient, suitable, and/or advantageous ranges for particular heat and/or cooling sources for a particular application. For example, water, carbon dioxide, refrigerants, and/or alcohols may be utilized, in one or more embodiments, although subject matter is not limited in scope in these respects. In one or more embodiments, suitable pressures may range from 0.03 Megapascals to 30.0 Megapascals absolute to match boiling points from −40° C. to 200° C., for example, although, again, subject matter is not limited in scope in these respects. In other embodiments, liquid 212 may have a boiling temperature of approximately between −10° C. and 50° C. at a higher pressure of system 200, for example, of up to approximately 500 bar and/or may have a boiling temperature of approximately between −20° C. and 40° C. at a lower pressure of system 200, for example, of up to approximately 50 bar. Again, subject matter is not limited in scope in these respects. Alternatively, in one or more embodiments, fluid 212 may comprise a mixture of multiple mixed gases and/or liquids that may provide a transition from relatively denser liquid to foam, such as may be observed on opening a bottle of carbonated water, for example. Non-limiting examples may include ammonia in water, carbon dioxide in water, and/or carbon dioxide in oil, in one or more embodiments.

In one or more embodiments, example system 200 may further comprise a pump 260 operably coupled to column 202 that may be utilized, for example, to regulate an overall pressure for column 202. In one or more embodiments, a suitable overall pressure may be specified to reduce and/or minimize energy transfer (e.g., energy loss) in heat exchangers 230 and 240, for example.

Continuing with FIG. 2 and example system 200, an additional power generating process may contribute to overall power generation capabilities of system 200, in one or more embodiments. For example, column 201 may be filled with a gas at (e.g., approximately) a specified pressure and/or temperature, which may be separate from pressure and/or temperature of column 202. In one or more embodiments, objects 220 may descend or fall through column 201 in a manner similar to that described above in connection with FIG. 1. For example, in one or more embodiments, power generated, in whole or in part, via descent of objects 220 through column 201 as a result of gravity force may be extracted, in whole or in part, by mechanical approaches. For example, in one or more embodiments, power “P2out” may be extracted, in whole or in part, via a power generator unit (not shown) by way of a cable and/or the like that may be pulled (e.g., in concert with a pulley system) by objects 220 as they descend. In one or more embodiments, objects 220 may be placed on supports and/or the like that may be operatively coupled, such as via cables and/or pulleys and/or the like, to a generator, for example. Any of a range of mechanical approaches for intermittently (e.g., during descent through column 201) operably coupling objects 220 to a power generator unit may be employed in one or more embodiments, for example.

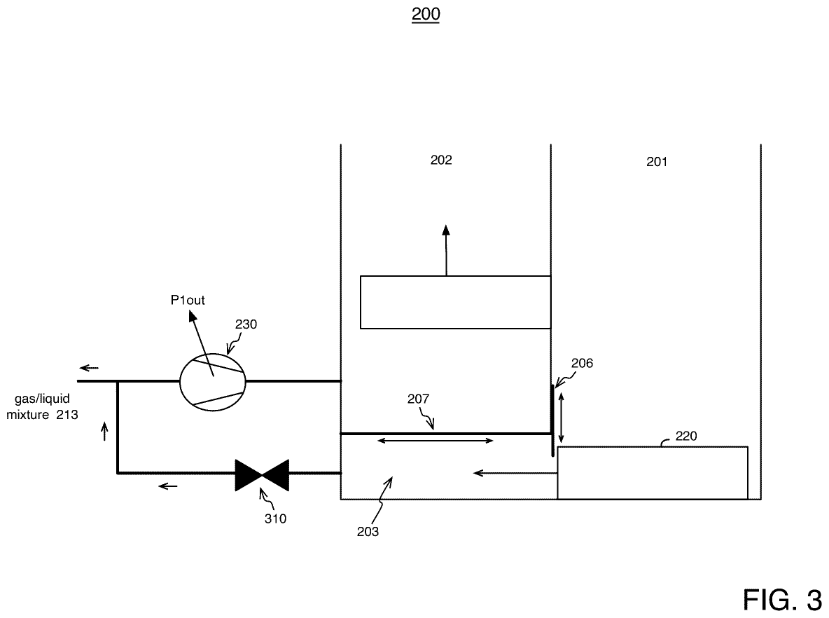

In one or more embodiments, as an object 220 arrives at a lower portion of column 201, object 220 may be inserted into a lower portion of column 202. It may be noted that, in one or more embodiments, pressure at such a level in liquid-filled column 202 may be significantly higher than that of gas-filled column 201. It may further be noted that inserting object 220 into column 202 at such a pressure may consume energy (e.g., most, all, or more of the energy) generated during the fall of object 220 through column 201. Embodiments described herein may comprise a mechanism and/or approach for inserting objects 220 into column 212 without requiring consumption of significant amounts of energy. See FIG. 3 and the accompanying description, below.

FIG. 3 is an illustration depicting an example mechanism and/or approach for inserting objects 220 from a lower portion of gas-filled column 201 to a lower portion of liquid-filled column 202, according to an embodiment. It may be noted that FIG. 3 depicts a number of elements similar to those depicted in FIG. 2. FIG. 3 is provided to better show some of the details in one or more embodiments, although subject matter is not limited in scope to the particular details depicted and/or described.

In one or more embodiments, liquid-filled column 202 may comprise a movable separator 207 (e.g., lid and/or the like) to separate compartment 203 from the remainder of column 202. In one or more embodiments, separator 207 may operate to slide and/or rotate in and out of place, such as via one or more motors, for example. It may be noted that moving separator 207 into position, such as by actuating a motor to rotate or slide separator 207 into position, for example, may not utilize relatively significant energy at least in part because pressure levels just above and just below separator 207 are significantly similar or the same, for example.

In one or more embodiments, once separator 207 is in place such as to partition compartment 203 from the remainder of column 202, a door 206 may be opened while object 220 is engaged with the opening to compartment 203 so that liquid 212 currently filling compartment 203 is not able to access gas-filled column 201. In one or more embodiments, door 206 may operate to slide up-and-down or side-to-side, for example. Further, in one or more embodiments, as door 206 is lifted (e.g., such as by sliding), a valve 310 (depicted in FIG. 3 but not depicted in FIG. 2) may open to allow liquid within compartment 203 to be pushed out of compartment 203 as object 220 is pushed into compartment 203, for example. Because pressures may be relatively balanced, this operation may utilize relatively little energy (e.g. may not utilize any significant energy), in one or more embodiments. It may be helpful to visual this example process as being comparable in some respects with a syringe where liquid (e.g., liquid 212) may be evacuated from a cylinder (e.g., compartment 203) with actuation of a plunger (e.g., object 220), for example.

In one or more embodiments, once object 220 is positioned within compartment 203, door 206 may be closed (e.g., slid back into place via actuation of a motor) and separator 207 may be opened (e.g., slid or rotated via actuation of a motor), thereby allowing object 220, with its density specified to be lower than fluid 212, to begin to ascend column 202, for example.

Returning to FIG. 2, at an upper portion of column 202, to transfer an object 220 from column 202 to column 201, a relatively similar mechanism may be employed. For example, a door 208 may be operable to slide, rotate, etc. so as to provide an opening through which object 220 may be pushed, such as via actuation of a motor and/or the like, into an upper portion of gas-filled column 201. In one or more embodiments, a partition, such as separator 207 that may be utilized at a bottom portion of column 202, may not be utilized at an upper portion of column 202 at least in part due to pressures at an upper level of column 201 and column 202 being relatively close in value, in one or more embodiments. Of course, subject matter is not limited in scope in these respects.

It may be noted that, at least in part via embodiments described herein, objects, such as objects 220, may cycle through a gas-filled column, such as column 201, and a liquid-filled column, such as column 202, without use of relatively significant amounts of energy (e.g., amount of energy expended to transfer an object between the two columns is less than the amount of energy generated during an object's descent through gas-filled column 201).

In one or more embodiments, a column, such as columns 201 and/or 202, for example, may be sized in accordance with particular applications. For example, for relatively smaller installations, such as for residential applications, for example, a column may have a height ranging from 1.0 meters to 100.0 meters and/or may have an interior volume suitable for a particular application, in one or more embodiments, although subject matter is not limited in scope in these respects. Also, for example, for larger installations, in one or more embodiments, a column may range from 100 meters to 10,000 meters and/or may have a suitable interior volume, although, again, subject matter is not limited in scope in these respects. In one or more embodiments, larger installations may include, for example, underground infrastructure or above-ground infrastructure (e.g., mountainous region), or a combination thereof.

As discussed above and/or as depicted in FIG. 2 and FIG. 3, power may be generated, in whole or in part, via at least two different approaches, in one or more embodiments. Of course, subject matter is not limited to two approaches. In one or more embodiments, a measure of power P1out may be generated, in whole or in part, via liquid flow down through column 202 through turbine 230, for example. A measure of power P2out may be generated, in whole or in part, via a mass, such as objects 220, descending or falling through a gas-filled column, such as column 201. In general, for example system 200, for example, a total amount of power generated may be expressed in accordance with relation 1, provided below.

$$Pout = P 1 out + P 2 out \qquad ( 1 )$$

In one or more embodiments, such as for example system 200, energy may be consumed in various ways to accomplish power-generating cycles. For example, a heat exchanger and/or the like, such as heat exchanger 240, may inject an amount of heat Qin to liquid 212 to boil-off at least a portion of liquid 212 to cause a resulting gas/liquid mixture 213 to flow upwards through column 245 towards an upper portion of column 202, in one or more embodiments. In one or more embodiments, it may be advantageous to consume an amount of energy within heat exchanger 240 to generate just enough heat to boil-off at least a portion of liquid 212 to cause liquid/gas mixture 213 to flow upwards through column 245 without injecting more heat and/or consuming more energy than may be needed to perform a suitable boil-off, for example.

In one or more embodiments, it may be advantageous to utilize as much natural energy as possible. For example, liquid 212 may be specified and/or selected to have a boiling point lower than a natural temperature (e.g., ambient temperature of a surrounding environment) at a bottom portion of column 202, in one or more embodiments. Also, in one or more embodiments, liquid 212 may be specified and/or selected to have a boiling point approximately at an ambient temperature at a suitable and/or expected working pressure. In this manner, an amount of energy to be injected via heat exchanger 240, for example, may be reduced, minimized, and/or eliminated, in one or more embodiments.

Also, in one or more embodiments, a heat exchanger and/or the like, such as heat exchanger 250, may remove an amount of heat Qout from gas/liquid mixture 213 provided, in whole or in part, via return column 245, for example, to reliquefy the mixture. In one or more embodiments, suitable materials and/or pressures for liquid 212 may be specified and/or selected to reduce or minimize an amount of energy consumed to reliquefy gas/liquid mixture 213, for example.

As alluded to above, example system 200 may comprise a pump 260 operably coupled to column 202. In one or more embodiments, pump 260 may control, in whole or in part, pressure within column 202 to improve, optimize, etc. energy inputs and/or outputs, in one or more embodiments. In one or more embodiments, pump 260 may increase or decrease overall pressure levels within column 202 without relatively significant energy contribution, for example. Also, in one or more embodiments, pump 260 may operate in an automatic and/or semi-automatic (e.g., with some observation, adjustment, maintenance, etc. performed by a human and/or external device) manner, such as a function of one or more temperature levels measured at a top portion of column 202 and/or a bottom portion of column 202, for example.

As may be gleaned from discussion herein, it may be advantageous to locate and/or position a system, such as example system 200, in an environment where a temperature at a lower level, such as a lower portion of column 202, is higher than a temperature at a higher level, such as an upper portion of column 202, in one or more embodiments. Such conditions may occur in many places in nature. For example, geothermal energy may ensure higher temperatures at lower portions of a column as compared with upper portions of a column. Also, for example, mountains may have sufficient change in altitude, in at least some cases, to ensure that lower temperatures may be measured at an upper portion of a mountain as compared to temperatures measured at a lower portion of the mountain. Positioning a renewable energy power generation system, such as example system 200, for example, within such environments may be advantageous to, for example, reduce an amount of energy utilized to boil-off at least a portion of liquid 212 and/or to reliquefy gas/liquid mixture 213, for example, in one or more embodiments.

It may again be noted that generation of energy and consumption of thermal energy may be independent from each other, in one or more embodiments. This characteristic may mean that a system, such as example system 200, may achieve significantly higher efficiencies than a thermal cycle limited at the Carnot efficiency (1−Tₘᵢₙ/Tₘₐₓ). Theoretically, for an infinite column height, efficiency of a cycle may approach 100%, as alluded to previously.

In one or more embodiments, an energy balance of a power generation cycle, such as for example system 200, for example, may be expressed in accordance with relation 2.

$$P = mdot * g * H - Q 1 dot - W * COP \qquad ( 2 )$$

### Wherein:

P represents an output power of a cycle;
mdot represents an average mass rate of active weights (e.g., objects 220);
H represents a height of a column;
Q1dot represents a heat flux utilized to boil-off a liquid in a liquid-flow cycle;
W represents a power utilized to reliquefy a gas or gas/liquid mixture in a liquid-flow cycle; and
COP represents a Coefficient of Performance for mechanisms, devices, etc. utilized in a reliquification process.

With respect to relation 2 shown above, it may be noted that as long as P is positive, a net gain in power generation may be realized, in one or more embodiments. It may further be noted that embodiments may be applied at any scale utilizing combinations of column sizes, heights, radii, etc. and/or liquids suitable to particular applications, for example. As mentioned, liquid 212 may be selected based, in whole or in part, on criteria including, for example, boiling/liquification curve, boiling/condensing characteristics, energy requirements (e.g., the lower the better in some embodiments), density (e.g., the higher the better in some embodiments), etc., in one or more embodiments.

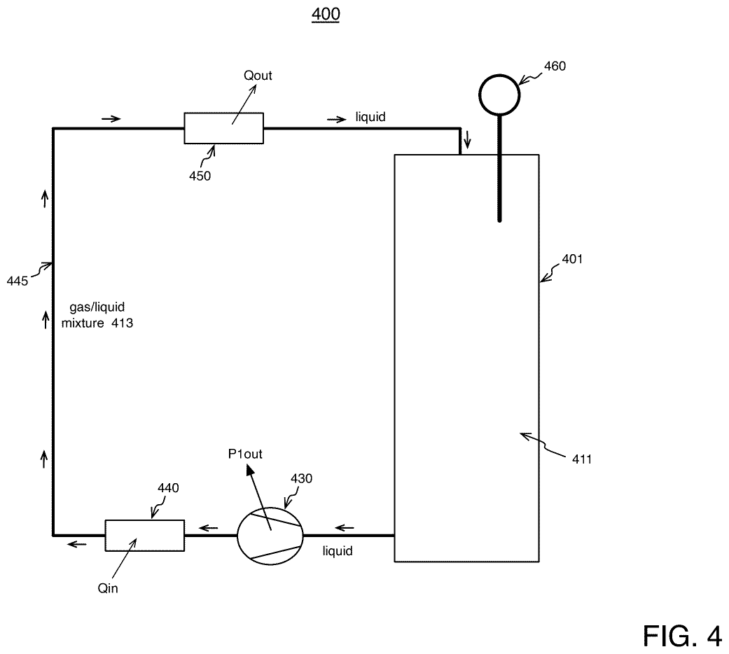

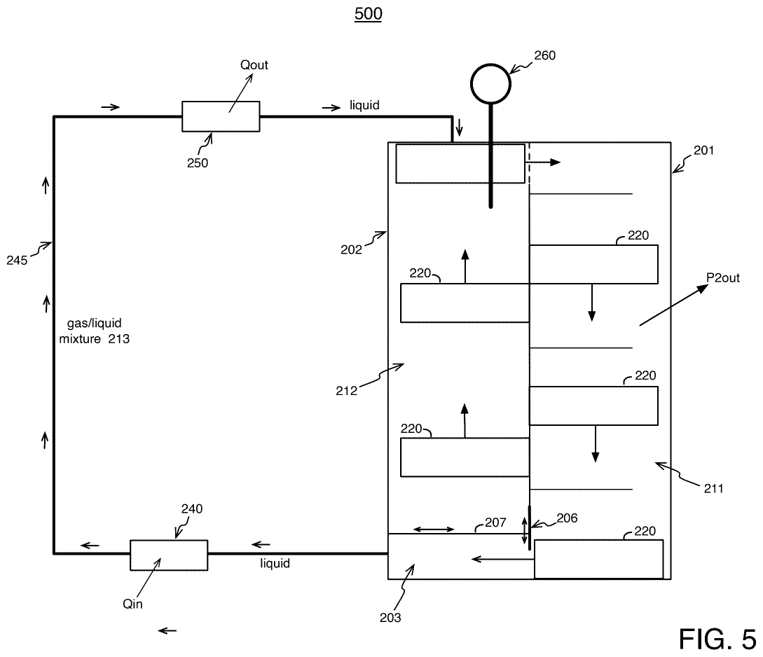

It may also be noted that a system, such as example system 200 depicted in FIG. 2 and FIG. 3, may be adapted, partitioned, and/or reconfigured, for example, into different independent power generation systems (e.g., two separate power generation systems), in one or more embodiments. See, for example, FIG. 4 and FIG. 5, discussed below.

FIG. 4 is an illustration depicting an example renewable power generation system 400 sharing some similarities and/or characteristics with example system 200, in accordance with an embodiment. However, in one or more embodiments, example system 400 may generate power solely via a descending liquid approach, such as discussed above, for example. In one or more embodiments, system 400 may comprise a column 401 containing a liquid 411 that is to flow from an upper portion of column 401 to a lower portion of column 401 and that is further to flow through a generator unit, such as turbine 430, for example. In one or more embodiments, system 400 may further comprise a mechanism (e.g., turbine 430, heat exchanger 440, column 445, and/or heat exchanger 450) to return liquid 212 from a lower portion of column 401 to an upper portion of column 401, for example. Example system 400 may also comprise a pump 460, for example, that may share characteristics with pump 260 discussed previously, in one or more embodiments.

FIG. 5 is an illustration depicting an additional relatively simpler system 500, wherein power may be generated solely by way of a descending mass approach, such as discussed above, in accordance with one or more embodiments. In one or more embodiments, system 500 may share many similarities and/or characteristics with example system 200, discussed above. For example, example system 500 may comprise a first column 201 containing a gas and a second column 202 containing a liquid, similar in at least some respects to system 200 discussed above. However, example system 500 may generate power, in whole or in part, via objects 220 descending through column 201. It may be noted that system 500 lacks a generator (e.g., see turbine 230 of system 200) to operate in conjunction with liquid-filled column 202, in one or more embodiments. It may also be noted that example system 500 includes a path (e.g., return column 245 and/or heat exchangers 240, 250) to return liquid 212 from a lower portion of column 202 to an upper portion of column 202. In one or more embodiments, this may allow for liquid 212 within compartment 203 to escape as object 220 is introduced through door 206 into compartment 203 in a manner such as discussed above in connection with example system 200, for example.

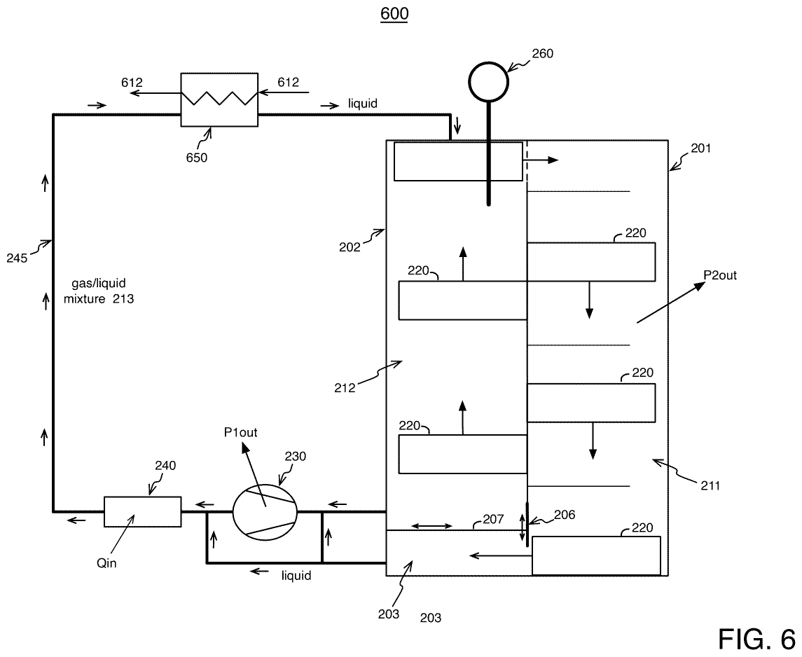

FIG. 6 is an illustration depicting an example renewable power generation system 600 further comprising one or more heat exchanger units 650 to draw thermal energy from a main liquid, such as liquid 212 and/or gas/liquid mixture 213, of a column, such as return column 245 and/or column 202, into a working fluid, such as working fluid 612, according to an embodiment. In one or more embodiments, system 600 may share similarities and/or characteristics with example systems 200, 400, and/or 500, discussed above, for example.

It may be noted that FIG. 6 shows, in accordance with one or more embodiments, an extension of example mechanisms, approaches, and/or process discussed herein for situations wherein a temperature difference between an upper portion and a lower portion of a liquid-filled column, such as column 202, is relatively more significant, such as a temperature difference of 40° C., for example, although subject matter is not limited in scope in these respects. In such a circumstance and/or configuration, a fluid that may be boiling-off at a lower level of system 600 to travel upwards, such as via column 245, may also be accumulating meaningful energy that may be used as thermal energy at an upper portion of system 600, such as at a top portion of column 245, for example, in one or more embodiments. In such a circumstance and/or configuration, in one or more embodiments, a substantially entire system, such as system 600, may approach executing a co-generation cycle, with yet higher overall energy efficiency, for example.

As depicted in FIG. 6, working fluid 612 may take an amount of thermal energy from main fluid 212 and/or gas/liquid mixture 213 by way of heat exchanger 650. Such thermal energy of working fluid 612 may be utilized in a wide range of applications, such as, for example, residential heating, industrial applications, etc., although subject matter is not limited in scope in these respects. Further, in one or more embodiments, transfer of thermal energy from gas/liquid mixture 213 and/or main fluid 212 to working fluid 612 may contribute to reliquefying and/or condensing gas/liquid mixture 213 and/or main fluid 212, for example. In one or more embodiments, this process may be accomplished, in whole or in part, by way of one or more heat exchangers, such as heat exchanger 650, for example. It may be noted that this or similar approach (e.g., drawing thermal energy into working fluid for additional applications) may also be applied to example systems 200, 400, and/or 500, in one or more embodiments.

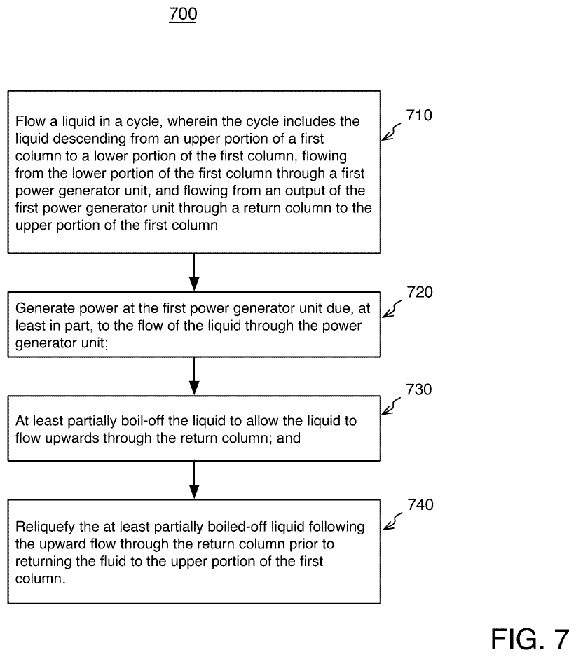

FIG. 7 is a flow diagram illustrating an example process 700 for generating power at least in part via a liquid flow, according to an embodiment. It should be appreciated that even though one or more operations are illustrated or described concurrently or with respect to a certain sequence, other sequences or concurrent operations may be employed. In addition, although the description below references one or more particular aspects and/or features illustrated in certain other figures, one or more operations may be performed with other aspects and/or features, for example. In one or more embodiments, example process 700 may include aspects discussed above, such as in connection with FIG. 2 and/or FIG. 4, for example. Of course, subject matter is not limited in scope in these respects.

As depicted at block 710 of FIG. 7, an example process, in accordance with one or more embodiments, may include flowing a liquid in a cycle, wherein a cycle may include liquid descending from an upper portion of a first column to a lower portion of the first column, flowing from the lower portion of the first column through a first power generator unit, and flowing from an output of the first power generator unit through a return column to the upper portion of the first column. As further depicted at block 720, example process 700, in accordance with one or more embodiments, may include generating power at a first power generator unit due, at least in part, to the flow of the liquid through the power generator unit.

In one or more embodiments, example process 700 may further include at least partially boiling-off a liquid to allow the liquid to flow upwards through a return column, as depicted at block 730. Additionally, in one or more embodiments, example process 700 may include reliquefying the at least partially boiled-off liquid following the upward flow through the return column prior to, or concurrent with, returning the fluid to the upper portion of the first column.

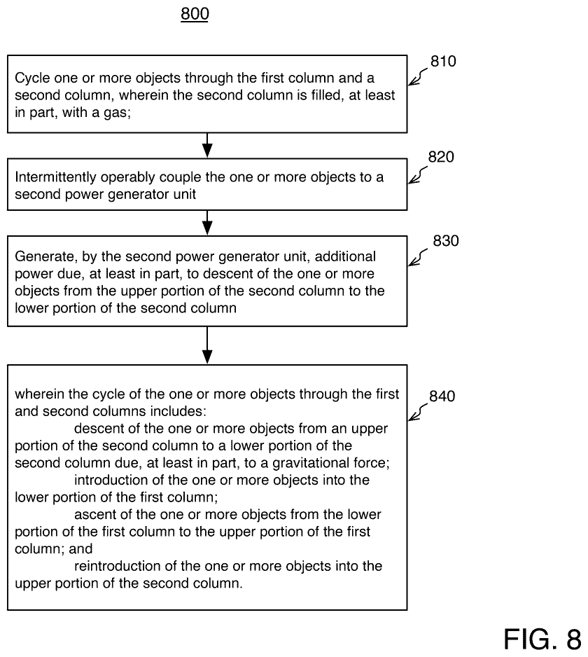

FIG. 8 is a flow diagram illustrating an example process 800 for generating power at least in part via descent of one or more objects due at least in part to a gravitational force, according to an embodiment. It should be appreciated that even though one or more operations are illustrated or described concurrently or with respect to a certain sequence, other sequences or concurrent operations may be employed. In addition, although the description below references one or more particular aspects and/or features illustrated in certain other figures, one or more operations may be performed with other aspects and/or features, for example. In one or more embodiments, example process 800 may include aspects discussed above, such as in connection with FIGS. 1-7, for example. Of course, subject matter is not limited in scope in these respects. It should further be appreciated that example process 800 shown in FIG. 8 may comprise an extension of example process 700 in one or more embodiments. In other embodiments, one or both of example processes 700 and 800 may be performed separately, for example.

As depicted at block 810 of FIG. 8, example process 800 may include cycling one or more objects through a first column and a second column, wherein the second column is filled, at least in part, with a gas (the first column being filled with a liquid—see example process 700, for example), in one or more embodiments. In one or more embodiments, example process 800 may further comprise intermittently operably coupling the one or more objects to a second power generator unit, as depicted at block 820, for example. Further, in one or more embodiments, example process 800 may include generating, by the second power generator unit, additional power due, at least in part, to descent of the one or more objects from the upper portion of the second column to the lower portion of the second column, as depicted at block 830, for example.

As further depicted at block 840 of FIG. 8, example process 800 may include, in one or more embodiments, cycling the one or more objects through the first and second columns by, for example, allowing descent of the one or more objects from an upper portion of the second column to a lower portion of the second column due, at least in part, to a gravitational force, introducing of the one or more objects into the lower portion of the first column, allowing ascent of the one or more objects from the lower portion of the first column to the upper portion of the first column, and/or reintroducing of the one or more objects into the upper portion of the second column, for example.

In the following discussion, a variety of embodiments are described that may or may not share characteristics and/or similarities with examples discussed above, such as in connection with example systems 200, 400, 500, and/or 600. Embodiments described below may comprise alternative approaches, additional approaches, etc. Of course, aspects described below may be utilized in conjunction with any of the aspects described previously, in one or more embodiments. Further, subject matter is not limited in scope to the particular details of the example embodiments discussed herein.

In one or more embodiments, a device for generating power may comprise: one or more columns comprising an interior portion separate from an exterior portion of the one or more columns exposed to ambient temperature and pressure; a liquid with a vaporization temperature in a range of the ambient temperature of the exterior portion of the one or more columns, wherein the temperature of the liquid in a lower interior portion of the one or more columns is higher than the temperature of the liquid in an upper interior portion of the one or more columns; a first heat exchanger operably connected to the liquid in the lower portion of the one or more columns; a second heat exchanger operably connected to the liquid in the upper portion of the one or more columns; a pump operably connected to the interior portion of the one or more columns capable of controlling the pressure within the interior portion of the one or more columns; and a turbine operably connected to the liquid in the lower portion of the one or more columns.

In one or more embodiments, one or more columns may have a height of between 1 to 10,000 meters. Also, in one or more embodiments, a liquid may have a boiling point at about an ambient temperature, at the operating pressure in the interior portion of the one or more columns. In one or more embodiments, a liquid may be selected from a group comprising materials with boiling points of between 10° C. and 50° C. at a higher pressure of up to 500 bar and/or of between −20° C. and 40° C. at a lower pressure of up to 50 bar.

Embodiments may further comprise one or more masses (e.g., objects) in the liquid contained in the one or more columns. In one or more embodiments, the masses may comprise any solids with densities lower than the density of the fluid used in the process. In one or more embodiments, one or more masses may be mechanically linked to a means for power generation, for example.

Embodiments may include a system for generating power comprising a device positioned in an exterior environment, wherein the device comprises: one or more columns comprising an interior portion separate from an exterior portion of the one or more columns exposed to ambient temperature and pressure; a liquid with a vaporization temperature in a range of the ambient temperature of the exterior portion of the one or more columns, wherein the temperature of the liquid in a lower interior portion of the one or more columns is higher than the temperature of the liquid in an upper interior portion of the one or more columns; a first heat exchanger operably connected to the liquid in the lower portion of the one or more columns; a second heat exchanger operably connected to the liquid in the upper portion of the one or more columns; a pump operably connected to the interior portion of the one or more columns capable of controlling the pressure within the interior portion of the one or more columns; a turbine operably connected to the liquid in the lower portion of the one or more columns; and wherein the device is positioned in an exterior environment where the ambient temperature exterior to the upper portion of the one or more columns is lower than the ambient temperature exterior to the lower portion of the one or more columns.

In one or more embodiments, a system may further comprise one or more masses in the liquid contained in the one or more columns wherein the one or more masses are mechanically linked to a means for power generation. In one or more embodiments, the exterior environment may be selected from the group comprising air or vapor of the liquid used in the process.

Embodiments may include a process for generating power comprising: providing a device or system, such as described above; controlling the temperature and pressure of the system such that the second heat exchanger operably connected to the liquid in the upper portion of the one or more columns liquifies gas in the upper portion of the one or more columns; and generating power from the turbine operably connected to the liquid in the lower portion of the one or more columns.

Embodiments may further include a process for generating power comprising: providing a system or device such as described herein; controlling the temperature and pressure of the system such that the second heat exchanger operably connected to the liquid in the upper portion of the one or more columns liquifies gas in the upper portion of the one or more columns; and generating power from the turbine operably connected to the liquid in the lower portion of the one or more columns or the one or more masses mechanically linked to a means for power generation or both.

In one or more embodiments, a process may further comprise introducing an amount of energy into the liquid at the first heat exchanger sufficient to reduce the density of the liquid to allow the liquid to flow to the upper portion of the one or more columns. In one or more embodiments, a process may further comprise introducing an amount of energy into the liquid at the first heat exchanger sufficient to reduce the density of the liquid to allow the liquid to flow to the upper portion of the one or more columns. In one or more embodiments, energy may be introduced by an electric heater. Additionally, for example a thermal efficiency may be such that an overall power produced may be positive.

Embodiments may include a system and/or device, such as system 600 depicted in FIG. 6, comprising multiple radial columns, such as between 2 and an unlimited number of columns, filled with liquid and some solid particles (e.g., objects 220) having a lesser density than the liquid. In one or more embodiments, torque created between particles found at higher radial levels and particles found at lower radial levels may create a rotation of the system and/or device, which may produce a shaft power similar to other turbines, for example. In one or more embodiments, a radius of the system and/or device may be anywhere between a few centimeters for very low power generation machines and several tens of meters for larger power generation units. In one or more embodiments, a liquid may have densities in a wide range, from several hundred kg/cubic meter to several thousand kg/cubic meter, for example. In one or more embodiments, it may be advantageous for the liquid to have a lower viscosity to allow freer movement of the solid particles (e.g., objects 220) with reduced and/or minimal friction, for example. In one or more embodiments, the solids (e.g., objects 220) may have a lower density than the gas in order to restart the process when the particles are at a high(er) radius, for example.

In one or more embodiments, a power generation process may be converted into a co-generation process (e.g., mechanical power due to the gravitational energy+thermal energy) when a thermal value at a bottom portion of a column is significant, such as in excess of 40° C., for example, although subject matter is not limited in scope in these respects.

In context of present patent application, term “connection,” term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. As another example, a tangible connection and/or tangible connection path may be made, such as a path comprising pipes or other means that are able to conduct liquid and/or gas, or a combination thereof, between two tangible components (e.g., container, column, tank, etc.).

Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. For connection paths pertaining to liquid or gas, or a combination thereof, tangible connection path may be open or closed, at times, resulting from influence of one or more valves, for example.

In a particular context of usage, such as a particular context in which tangible components are being discussed, therefore, terms “coupled” and/or “connected” may be used in a manner so that terms are not synonymous. Similar terms may also be used in a manner in which a similar intention is exhibited. Thus, “connected” may be used to indicate that two or more tangible components and/or like, for example, are tangibly in direct physical contact. Thus, using previous example, two tangible components that are connected via one or more pathways for liquid or gas, or a combination thereof, are physically connected via a tangible connection, as previously discussed. However, “coupled,” may be used to mean that potentially two or more tangible components are tangibly in direct physical contact. Nonetheless, “coupled” is also used to mean that two or more tangible components and/or like are not necessarily tangibly in direct physical contact, but are able to co-operate, liaise, and/or interact. Likewise, term “coupled” is also understood to mean indirectly connected.

Additionally, in the present patent application, in a particular context of usage, such as a situation in which tangible components, objects, substances, materials, etc. are being discussed, a distinction exists between being “on” and/or being “over.” As an example, location or placement of a component, object, substance, material, etc. “on” another component, object, substance, material, etc. refers to direct physical and/or tangible contact without an intermediary; nonetheless, location or placement “over” a component, object, substance, material, etc., while understood to potentially include location or placement “on” a component, object, substance, material, etc. (since being “on” may also accurately be described as being “over”), is understood to include a situation in which one or more intermediaries, such as one or more intermediary components, objects, substances, materials, etc., are present between components, objects, substances, materials, etc. so that such components, objects, substances, materials, etc. are not necessarily in direct physical and/or tangible contact.

A similar distinction is made in an appropriate particular context of usage, such as in which tangible components, objects, substances, materials, etc. are discussed, between being “beneath” and/or being “under.” While “beneath,” in such a particular context of usage, is intended to necessarily imply physical and/or tangible contact (similar to “on,” as just described), “under” potentially includes a situation in which there is direct physical and/or tangible contact, but does not necessarily imply direct physical and/or tangible contact, such as if one or more intermediaries, such as one or more intermediary components, objects, substances, materials, etc., are present. Thus, “on” is understood to mean “immediately over” and/or “beneath” is understood to mean “immediately under.”

It is likewise appreciated that terms such as “over” and/or “under” are understood in a similar manner as terms “up,” “down,” “top,” “bottom,” and/or so on, previously mentioned. These terms may be used to facilitate discussion, but are not intended to necessarily restrict scope of claimed subject matter. For example, term “over,” as an example, is not meant to suggest that claim scope is limited to only situations in which an embodiment is right side up, such as in comparison with embodiment being upside down, for example. Thus, if an object, as an example, is within applicable claim scope in a particular orientation, such as upside down, as one example, likewise, it is intended that latter also be interpreted to be included within applicable claim scope in another orientation, such as right side up, again, as an example, and/or vice-versa, even if applicable literal claim language has potential to be interpreted otherwise. Of course, again, as always has been case in specification of a patent application, particular context of description and/or usage provides helpful guidance regarding reasonable inferences to be drawn.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, that the particular situation be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall with the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more forces, signal samples and/or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modelled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand/or appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of historical measurements, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more measurements.

It is further noted that terms “type” and/or “like,” if used, such as with a feature, structure, characteristic, and/or like, using “optical” or “electrical” as simple examples, means at least partially of and/or relating to feature, structure, characteristic, and/or like in such a way that presence of minor variations, even variations that might otherwise not be considered fully consistent with feature, structure, characteristic, and/or like, do not in general prevent feature, structure, characteristic, and/or like from being of a “type” and/or being “like,” (such as being an “optical-type” or being “optical-like,” for example) if minor variations are sufficiently minor so that feature, structure, characteristic, and/or like would still be considered to be substantially present with such variations also present. Thus, continuing with this example, terms optical-type and/or optical-like properties are necessarily intended to include optical properties. Likewise, terms electrical-type and/or electrical-like properties, as another example, are necessarily intended to include electrical properties. It should be noted that specification of present patent application merely provides one or more illustrative examples and/or claimed subject matter is intended to not be limited to one or more illustrative examples; however, again, as has always been case with respect to specification of a patent application, particular context of description and/or usage provides helpful guidance regarding reasonable inferences to be drawn.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. An apparatus, comprising:
a first column to contain a liquid, wherein the first column comprises an upper portion and a lower portion;
a first power generator unit operably coupled to a lower portion of the first column via a first conduit; and
a return column operably coupled to an output of the first power generator unit and further operably coupled to an upper portion of the first column;
wherein the liquid is to flow in a cycle including descending from the upper portion of the first column to a lower portion of the first column, from the lower portion of the first column through the first power generator unit, from an output of the first power generator unit through the return column to the upper portion of the first column;
wherein the first power generator unit is to generate power due, at least in part, to flow of the liquid through the power generator unit; and
wherein the liquid is to at least partially boil-off to allow the liquid to flow upwards through the return column and wherein the at least partially boiled-off liquid is to reliquefy following the upward flow through the return column prior to returning to the upper portion of the first column.

2. The apparatus of claim 1, wherein the liquid is to at least partially boil-off due, at least in part, to ambient and/or environmental temperature conditions and/or liquid pressure conditions at or about a lower portion of the return column.

3. The apparatus of claim 1, further comprising a first heat exchange unit operably coupled between the output of the first power generator unit and the lower portion of the return column, wherein the liquid is to at least partially boil-off due, at least in part, to heat introduced into the liquid via the first heat exchange unit.

4. The apparatus of claim 1, further comprising a second heat exchange unit operably coupled between an upper portion of the return column and the upper portion of the first column, wherein the at least partially boiled-off liquid is to reliquefy due at least in part to heat removed from the at least partially boiled-off liquid via the second heat exchange unit.

5. The apparatus of claim 4, wherein the second heat exchange unit further operably coupled to a work fluid conduit to transfer heat from the at least partially boiled-off liquid to a work fluid, wherein the work fluid is to be utilized in a residential heating application and/or the like.

6. The apparatus of claim 1, further comprising a pump operably coupled to the first column, wherein the pump is to control a pressure level within the first column.

7. The apparatus of claim 1, wherein the first power generator unit comprises a turbine.

8. The apparatus of claim 1, further comprising:
a second column to be filled, at least in part, with a gas;
a second power generator unit; and
one or more objects operably coupled to the second power generator unit;
wherein the one or more objects are to cycle through the first and second columns at least in part via:
descent of the one or more objects from an upper portion of the second column to a lower portion of the second column due, at least in part, to a gravitational force;
introduction of the one or more objects into the lower portion of the first column;
ascent of the one or more objects from the lower portion of the first column to the upper portion of the first column; and
reintroduction of the one or more objects into the upper portion of the second column;
wherein the second power generator unit is to generate power due, at least in part, to the descent of the one or more objects from the upper portion of the second column to the lower portion of the second column.

9. The apparatus of claim 8, wherein the one or more objects are operably coupled to the second power generator unit at least in part by way of a system of one or more supports, one or more cables, and/or one or more pulleys.

10. The apparatus of claim 8, further comprising a mechanism to introduce the one or more objects into the lower portion of the first column from the lower portion of the second column, wherein the mechanism includes:
a movable separator to define, at least in part, a compartment at the lower portion of the first column separate from a remainder of the first column;
a movable door to provide access to the compartment at the lower portion of the first column from the lower portion of the second column; and
a conveyer device to cause the one or more objects to push into the compartment at the lower portion of the first column from the lower portion of the second column.

11. The apparatus of claim 10, wherein fluid from the compartment at the lower portion of the first column is pushed, at least in part, to the first power generator unit due at least in part to introduction of the one or more objects into the compartment at the lower portion of the first column.

12. The apparatus of claim 10, wherein the one or more objects have a density that is lower than a density of the fluid, and wherein, responsive at least in part to the one or more objects having been introduced into the compartment at the lower portion of the first column, the movable door is closed and the moveable separator is removed to allow the one or more objects to ascend from the lower portion of the first column to the upper portion of the first column.

13. A method, comprising:
flowing a liquid in a cycle, wherein the cycle includes the liquid descending from an upper portion of a first column to a lower portion of the first column, flowing from the lower portion of the first column through a first power generator unit, and flowing from an output of the first power generator unit through a return column to the upper portion of the first column;
generating power at the first power generator unit due, at least in part, to the flow of the liquid through the power generator unit;
at least partially boiling-off the liquid to allow the liquid to flow upwards through the return column; and
reliquefying the at least partially boiled-off liquid following the upward flow through the return column prior to returning the fluid to the upper portion of the first column.

14. The method of claim 13, wherein the at least partially boiling-off the liquid is accomplished due, at least in part, to ambient and/or environmental temperature conditions and/or liquid pressure conditions at or about a lower portion of the return column.

15. The method of claim 13, further comprising operably coupling a first heat exchange unit between the output of the first power generator unit and the lower portion of the return column, wherein the at least partially boiling-off the liquid includes introducing heat into the liquid via the first heat exchange unit.

16. The method of claim 13, further comprising operably coupling a second heat exchange unit between an upper portion of the return column and the upper portion of the first column, wherein the reliquefying the at least partially boiled-off liquid following the upward flow through the return column includes removing heat from the at least partially boiled-off liquid via the second heat exchange unit, and wherein the second heat exchange unit further operably coupled to a work fluid conduit to transfer heat from the at least partially boiled-off liquid to a work fluid, wherein the work fluid is to be utilized in a residential heating application and/or the like.

17. The method of claim 13, further comprising:
cycling one or more objects through the first column and a second column, wherein the second column is filled, at least in part, with a gas;
intermittently operably coupling the one or more objects to a second power generator unit; and
generating, by the second power generator unit, additional power due, at least in part, to descent of the one or more objects from the upper portion of the second column to the lower portion of the second column;
wherein the cycling the one or more objects through the first and second columns includes:
allowing the descent of the one or more objects from an upper portion of the second column to a lower portion of the second column due, at least in part, to a gravitational force;
introducing of the one or more objects into the lower portion of the first column;
allowing ascent of the one or more objects from the lower portion of the first column to the upper portion of the first column; and
reintroducing of the one or more objects into the upper portion of the second column.

18. The method of claim 17, wherein introducing of the one or more objects into the lower portion of the first column includes:
actuating a movable separator to define, at least in part, a compartment at the lower portion of the first column separate from a remainder of the first column;
actuating a movable door to provide access to the compartment at the lower portion of the first column from the lower portion of the second column; and
pushing, via a conveyor device, the one or more objects into the compartment at the lower portion of the first column from the lower portion of the second column.

19. The method of claim 18, further comprising pushing fluid from the compartment at the lower portion of the first column to the first power generator unit due at least in part to introduction of the one or more objects into the compartment at the lower portion of the first column.

20. The method of claim 18, wherein the one or more objects have a density that is lower than a density of the fluid, and wherein, responsive at least in part to introducing the one or more objects into the compartment at the lower portion of the first column, closing the movable door and the removing the moveable separator to allow the one or more objects to ascend from the lower portion of the first column to the upper portion of the first column.
